(19) United States
(12) Patent Application Publication
(10) Pub. No.: US 2009/0035961 A1
(43) Pub. Date: Feb. 5, 2009

(54) Surface Mount Electrical Connector

(76) Inventor: Junya Tsuji, Tokyo (JP)

Correspondence Address: BARLEY SNYDER, LLC, 1000 WESTLAKES DRIVE, SUITE 275, BERWYN, PA, 19312, US

(21) Appl. No.: 11/813,996

(22) PCT Filed: Dec. 12, 2005
(86) PCT No.: PCT/JP2005/023187

§ 371 Date: Jul. 14, 2007

(30) Foreign Application Priority Data
Jan. 18, 2005 (JP) 2005-9838

(51) Int. Cl. H01R 12/00

(52) U.S. Cl. 439/78

(57) ABSTRACT

A surface mount electrical connector for mounting to a substrate comprising a housing and a contact carried by the housing, the contact comprising a retention section held by the housing and a tine configured for mounting to a surface of the substrate wherein the tine extends from the retention section and wherein the tine lies inside an outer contour line of the housing is disclosed. A method of connecting a surface mount electrical connector to a substrate comprising the steps of providing a housing carrying a contact, the contact having a tine within a projected footprint of the housing on the substrate, attaching the housing to the substrate, inserting a jig into an opening of the housing, and bending the tine toward the substrate is disclosed.

### TECHNICAL FIELD

The present invention relates to an electrical connector, and more specifically, to a surface mount electrical connector in which tines of electrical contacts held by the electrical connector are surface mounted on a circuit board.

### BACKGROUND ART

Various types of surface mount electrical connectors are known. As an example, a memory card connector device that comprises a contact block, having contacts held therein, provided in the rear portion of the connector body, and a slider that moves within the connector body in the forward-backward directions according to an insertion/removal operation of a card is known as described, for example, in Japanese Unexamined Patent Publication No. 2004-207168 (FIGS. 5, 6). The contact block used in the connector device comprises a heart cam groove, which collaborates with a lock metal that moves therein to form what is known as the push-push connector. In the connector device, the tines of the contacts are protruding externally from the connector body so as to be surface mounted on a circuit board.

Recently, electronic devices, such as digital cameras, personal computers, and the like, have been made compact, and along with this, it is customary that electrical/electronic components incorporated in electronic devices are densely surface mounted on a circuit board. In order to densely surface mount electrical/electronic components, there has been a demand that the electrical/electronic components be made small so as to occupy small areas on the circuit board. This also allows the circuit board itself to be made compact.

In such a surface mount electrical connector, it is customary that the tines of contacts protrude externally from the connector and are soldered to the circuit board, as in the connector device disclosed in Japanese Unexamined Patent Publication No. 2004-207168. Tines are disposed so as to have the same gap with respect to the circuit board. Generally, the gap is not greater than 0.1 mm. The gap between each tine and circuit board, however, may be increased due to warpage of a housing to which the contacts are attached. For example, too large of a gap causes improper soldering, and thereby a defective product is produced. In order to avoid this, and in order to obtain coplanarity of the tines with respect to the circuit board, the gap between each tine and the circuit board is detected, and if the gap is greater than a predetermined value, the tine is pressed toward the circuit board using a jig so that the gap falls within a predetermined range. Therefore, it is convenient for detecting the coplanarity and verification of proper soldering, if the tines are protruding externally from the connector holding the contacts. Further, the protrusion of the tines may facilitate correction of the coplanarity. The protrusion of the tines, however, poses a problem that the area of the circuit board occupied by the connector is increased.

The present invention has been developed in view of the circumstances described above, and it is an object of the present invention to provide a compact surface mount electrical connector which requires a small area on the circuit board, yet allows tine coplanarity adjustment.

### DISCLOSURE OF THE INVENTION

The surface mount electrical connector of the present invention is an electrical connector which comprises an insulative housing mounted on a circuit board and a plurality of aligned electrical contacts, each having a held section which is held by the housing, and a tine of each of the electrical contacts is formed in a manner so as to be surface mounted on the circuit board, wherein:

the tine extends from the held section and remains inside of an outer contour line of the housing projected on the circuit board; the housing has an opening or a notch that allows access to the tine from outside of the housing; and coplanarity of the tines with respect to the circuit board is achievable by correcting a displacement of the tine with a jig inserted from the opening or notch.

As one embodiment of the present invention, a configuration may be adopted in which the held section of the electrical contact extends substantially parallel to the circuit board, the tine is folded back in a U-shape toward the held section and on the side facing the circuit board, and a hole that allows insertion of the jig toward the tine is provided at a position of the electrical contact corresponding to the opening or notch of the housing.

The referent of “aligned electrical contacts” as used herein means, for example, the electrical contacts disposed slightly in a zigzag pattern but basically maintaining the directionality, as well as those accurately disposed in a straight line.

According to the surface mount electrical connector of present invention, the tine remains inside of an outer contour line projected on the circuit board, the housing has an opening or a notch that allows access to the tine from outside of the housing, and coplanarity of the tines with respect to the circuit board is achievable by correcting a displacement of the tine with a jig inserted from the opening or notch. This arrangement may keep the entire portion of the tine inside of an outer contour line of the housing, so that the area of the circuit board occupied by the connector may be reduced. Further, a jig may be inserted through the opening or notch that allows access to the tine, so that coplanarity adjustment for the tines may be performed easily.

If the held section of the electrical contact extends substantially parallel to the circuit board, the tine is folded back in a U-shape toward the held section and on the side facing the circuit board. A hole that allows insertion of the jig toward the tine is provided at a position of the electrical contact corresponding to the opening or notch of the housing. The area of the circuit board occupied by the surface mount electrical connector may be reduced without protruding the tine into outside of the outer contour of the housing even the other portions of the contact overlap with the tine on the upper side.

### BRIEF DESCRIPTION OF THE DRAWINGS

FIG. 1A is a front view of a surface mount electrical connector according to an embodiment of the present invention, illustrating an overview thereof.

FIG. 1B is a plan view of the surface mount electrical connector shown in FIG. 1A, illustrating an overview thereof.

FIG. 1C is a rear view of the surface mount electrical connector shown in FIG. 1A, illustrating an overview thereof.

FIG. 2A is a bottom view of the surface mount electrical connector shown in FIG. 1A.

FIG. 2B is a left side view of the surface mount electrical connector shown in FIG. 1A.

FIG. 2C is a right side view of the surface mount electrical connector shown in FIG. 1A.

FIG. 3 is a partially enlarged cross-sectional view taken along the line 3-3 in FIG. 1B.

FIG. 4 is an enlarged plan view of an electrical contact with a carrier strip.

FIG. 5A is a side view of the electrical contact separated from the carrier strip.

FIG. 5B is a bottom view of the electrical contact separated from the carrier strip.

### BEST MODE FOR CARRYING OUT THE INVENTION

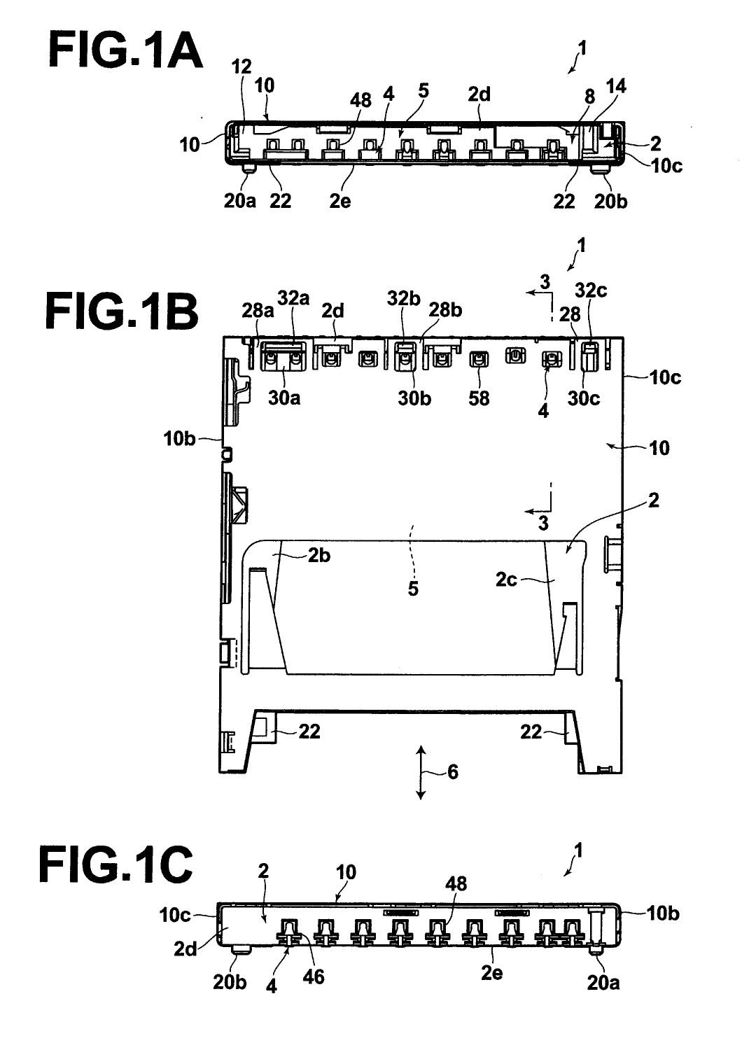

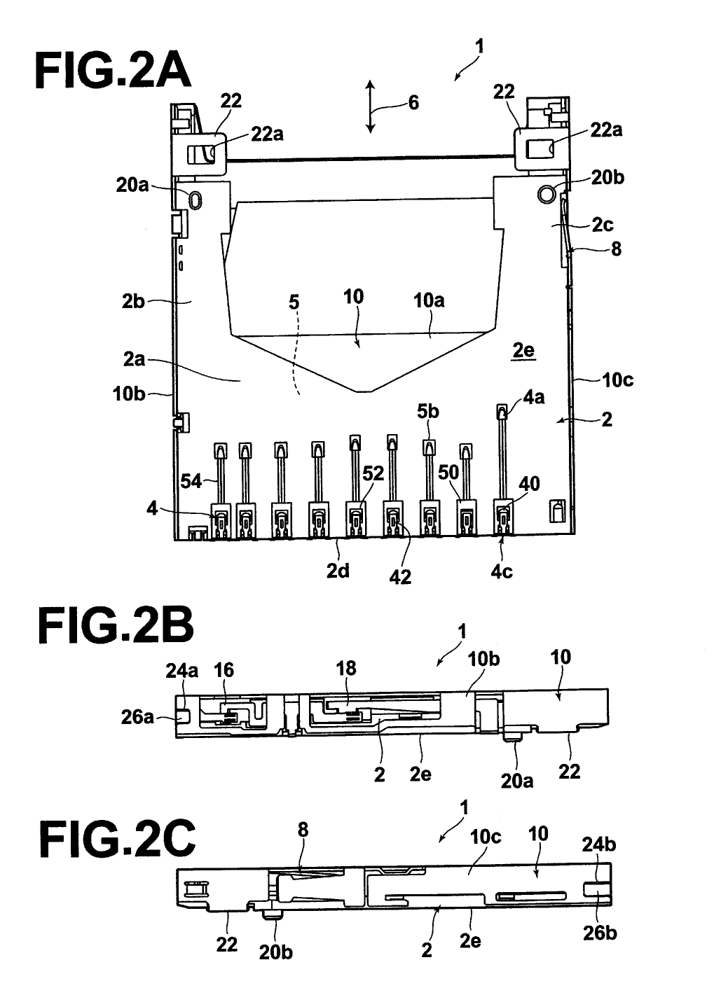

Hereinafter, an exemplary embodiment of a surface mount electrical connector (hereinafter, simply referred to as “connector”), of the present invention will be described with reference to the accompanying drawings. First, an overview of the connector 1 will be described with reference to FIGS. 1A to 2C. FIGS. 1A to 1C and FIGS. 2A to 2C illustrate overviews of the connector 1, in which FIG. 1A is a front view, FIG. 1B is a plan view, FIG. 1C is a rear view, FIG. 2A is a bottom view, FIG. 2B is a left side view, and FIG. 2C is a right side view. In the following description, the referent of “front” means a side from where a card (not shown) is inserted, and “rear” means a side opposite to the front in the plan view of the connector 1 in FIG. 1B. The connector 1 is a card connector and comprises a housing 2, contacts 4 held by the housing 2, an ejection mechanism 8, and a metal shell 10 attached to the housing and substantially covers these components. The ejection mechanism 8 is a mechanism that moves along card insertion-removal directions 6 (FIGS. 1B, 2A) according to insertion/removal of a card.

The housing 2 comprises a housing body 2a located in the rear portion thereof, and card guides 2b, 2c extending from the housing body 2a to the front side. The housing body 2a is open on the upper side and comprises a rear wall 2d at the rear end. The card guides 2b, 2c comprise card guide paths 12, 14 respectively on the inner side thereof (FIG. 1A). The card guide paths 12, 14 extend to the inside of the housing body 2a. The card guide 2b comprises contacts 16, 18 (FIG. 2B) for detecting insertion of a card or readiness of the card for write operation, but these are not the subject matter of the present invention and will not be described in detail here. The bottom surface 2e of the housing 2 is substantially flat, but comprises positioning bosses 20a and 20b at the front end of the card guide 2b, 2c respectively.

The card guide 2c comprises an ejection mechanism 8 which is formed such that when a card is inserted into the connector 1 from the front side and pushed into inside thereof, the card is held at the position, and when the card is pushed again, it is ejected. The ejection mechanism 8 comprises a not shown slider which operates by an insertion/ejection operation. The slider is constantly urged by a spring toward the front side of the housing. The ejection mechanism 8 comprises a heart-shaped cam groove (not shown) like that as disclosed in Japanese Unexamined Patent Publication No. 2004-207168 described earlier, and a cam follower (not shown) that moves within the cam groove. This structure is well known in the art, and in addition, it is not the subject matter of the present invention, so that it will not be described in detail here.

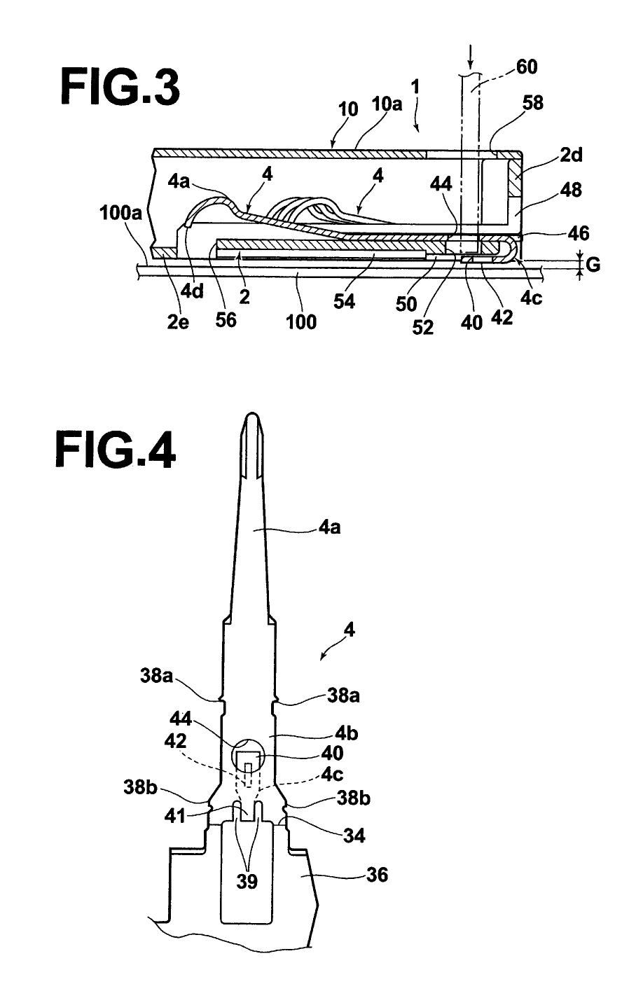

Next, the description will be directed to the shell 10. It is formed of a single metal plate through punching and folding, and comprises a principal surface 10a (FIG. 1B) that covers the upper side of the housing 2, and side walls 10b, 10c folded over the outer sides of the card guides 2b, 2c respectively. Protruding rectangular attachment pieces 22 (FIG. 2A) are provided at places adjacent to the front end of the respective card guides 2b, 2c, which are folded to the under surface of the card guides 2b, 2c. This prevents the shell 10 from moving upward from the housing 2. Each attachment piece 22 comprises a rectangular opening 22a in the center and is soldered to a circuit board (substrate) 100 (FIG. 3). The principal surface of the shell 10, attached to the housing 2, and housing 2 define a card receiving section 5.

As illustrated in FIGS. 2B, 2C, notches 24a, 24b open to the rear side are provided on the side walls 10b, 10c respectively. In the mean time, protrusions 26a, 26b, each corresponding to each of the notches 24a, 24b, are provided on the side surfaces of the card guides 2b, 2c respectively. Engagement of the notches 24a, 24b with the protrusions 26a, 26b prevents the shell 10 from moving upward and backward of the housing 2. The shell 10 comprises, at the rear end portion of the principal surface 10a, lock tongues 28a, 28b, 28c, which are free at the rear end. The lock tongues 28a, 28b, 28c comprise rectangular lock holes 30a, 30b, 30c respectively. Further, projecting bars 32a, 32b, 32c, each corresponding to each of the lock holes 30a, 30b, 30c, are provided at the rear wall 2d of the housing 2. The engagement of the lock holes 30a, 30b, 30c with the projecting bars 32a, 32b, 32c prevents the shell 10 from moving the front side of the housing 2.

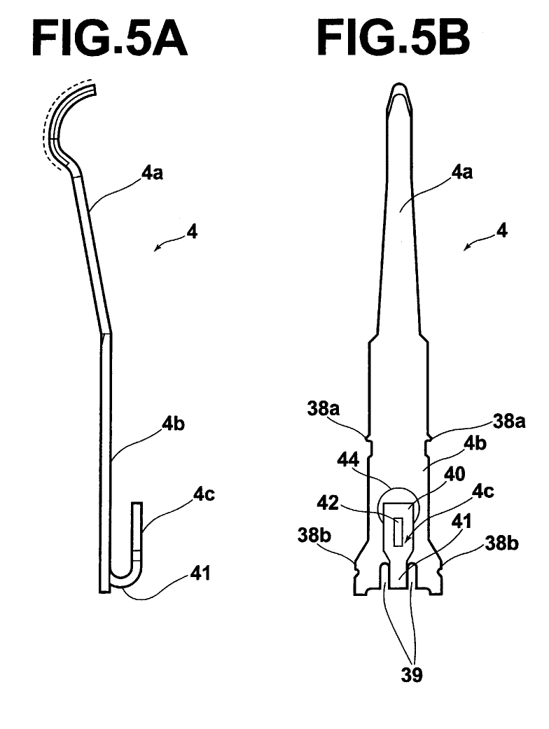

Next, description will be directed to the contact 4 and attachment thereof to the housing 2 with reference also to FIGS. 3 to 5B. FIG. 3 is a partially enlarged cross-sectional view taken along the line 3-3 in FIG. 1B. FIG. 4 is an enlarged plan view of a contact 4 with a carrier strip. FIG. 5A is a side view of the contact 4 separated from the carrier strip, and FIG. 5B is a bottom view thereof. First, the contact 4 will be described with reference to FIGS. 4 to 5B. The contact 4 comprises a narrow width contact segment 4a, a wide width held section 4b, and a tine 4c folded back in a U-shape from the held section 4b. A notch or groove 34, V-shaped in cross section and extending in the direction orthogonal to the axis line along the longitudinal direction of the contact 4, is formed at the rear end of the contact 4. The contact 4 is connected to the carrier strip 36 via the groove 34, and separated therefrom by the groove 34.

Lock protrusions 38a, 38b, spaced apart with each other, are formed at each side edge of the held section 4b. When the contact 4 is inserted into a contact insertion groove 46, to be described later, of the housing 2, the lock protrusions 38a, 38b engage with the contact insertion groove 46 and fixed to the housing 2. The contact segment 4a is narrower in width than the held section 4b, biased from the held section 4b, and has an arc shaped tip. Two slots 39, 39, open to the rear side, are formed at the rear end of the contact 4. A narrow width connection section 41 of the tine 4c extends in a U-shape between the slots 39, 39, followed by a wide width soldering portion 40, which is parallel to the held section 4b. The soldering portion 40 comprises a rectangular opening 42 in the center. Further, a hole 44 is provided at a position of the held section 4b right above the soldering portion 40. The hole 44 is a passage hole of a jig 60 (FIG. 3) for gaining access to the soldering portion 40 of the tine 4c.

Next, the description will be directed to the state in which the contact 4 is attached to the housing 2 with reference to FIGS. 1A to 3 again. As illustrated in FIG. 3, the housing 2 comprises a contact insertion groove 46 extending forward along the bottom surface 2e from the rear wall 2d. The contact insertion groove 46 has a width which allows the held section 4b of the contact 4 to be engaged therewith. Further, a contact insertion opening 48 is provided on the rear wall 2d to allow the contact 4 to be inserted through the rear wall 2d. The housing 2 comprises a rectangular depression 50 for accommodating the soldering portion 40 of the tine 4c, and a rectangular opening 52 vertically running through the housing 2 is provided at a position corresponding to the soldering portion 40 placed in the depression 50. The opening 52 of the housing is also communicating with the hole 44 of the contact 4.

The bottom surface 2e of the housing 2 comprises a groove 54, V-shaped in cross-section and extending forward from the depression 50 along the card insertion-ejection directions. The groove 54 is provided for reducing thermal stress when the connector 4 is mounted, and formed to the tip of the contact segment 4d and an escape hole 56. The escape hole 56 runs upward through the housing 2 from the bottom surface 2e. The escape hole 56 is provided for the tip 4d of the contact segment 4 not to interfere with the housing 2 by bending toward the housing 2 when a card is inserted. The principal surface 10a of the shell 10 comprises an opening 58 formed aligned with the tine 4c, opening 52, and hole 44. When the contact 4 is attached to the housing 2, the tine 4c is located inside of the rear wall 2d, as illustrated in FIG. 3. In other words, the tine 4c remains inside of the outer contour line of the housing 2. This is clearly illustrated in FIGS. 1B and 2A.

The description will now be directed to a method for correcting the coplanarity of the tines 4c of the contacts 4 structured in the manner as described above. A situation requiring correction of the position of the tine 4c, i.e., the height of the tine 4c from the substrate 100 means a case in which the housing 2 has deformed after forming, and a gap G which is greater than a predetermined value has developed, as illustrated in FIG. 3. The gap G may be detected, for example, by monitoring the connector 1 from the rear side by a camera, and determining variations in the gap G on the image. When a correction is performed, a stick-like jig 60 is inserted from the opening 58 of the shell 10 to the tine 4c through the hole 44 of the contact 4 and opening 52 of the housing 2, and the soldering portion 40 is pressed downward, i.e., toward the substrate 100 by the jig 60. This forces the soldering portion 40 to be displaced downward and the gap G falls within a predetermined range. Generally, the jig 60 has a bottom dead center set thereto to limit the traveling (moving distance) of the jig to a predetermined value, and attached to a machine. The correction of the tine 4c is completed by a single pressing operation of the jig 60. Thereafter, the appropriately positioned soldering portion 40 is soldered to the substrate 100.

So far an exemplary embodiment of the present invention has been described, but the present invention is not limited to this, and it will be obvious to those skilled in the art that various changes and modifications may be made without departing from the scope of the invention. For example, in the present embodiment, the opening 52 of the housing 2 and hole 44 of the contact 4 for inserting the jig 60 have rectangular and circular shapes respectively, but they may have a polygonal shape, oval shape, and the like. Further, the opening 52 may have a notch shape, other than an opening with closed perimeter formed in the housing 2.

1-2. (canceled)

3. A surface mount electrical connector for mounting to a substrate, comprising:
a housing; and
a contact supported by the housing, the contact comprising a retention section held by the housing and a tine configured for mounting to a surface of the substrate;
wherein the tine extends from the retention section and wherein the tine lies inside an outer contour line of the housing.

4. The surface mount electrical connector of claim 3, wherein the outer contour line of the housing is defined by a footprint of the housing as projected onto the substrate from above the housing.

5. The surface mount electrical connector of claim 3, wherein the outer housing comprises an opening allowing access to the tine from outside the housing.

6. The surface mount electrical connector of claim 3, wherein the outer housing comprises an opening allowing access to the tine from above the housing.

7. The surface mount electrical connector of claim 3, wherein the contact has a hole in the retention section aligned substantially above the tine.

8. The surface mount electrical connector of claim 3, wherein at least a portion of the tine lies substantially below the retention section.

9. The surface mount electrical connector of claim 3, wherein the tine is substantially U-shaped and at least a portion of the tine lies substantially below the retention section.

10. The surface mount electrical connector of claim 3, wherein the outer housing comprises an opening substantially aligned with a hole of the retention section and wherein the opening and the hole allow access to the tine from above the housing.

11. The surface mount electrical connector of claim 3, wherein the tine is configured for deformation toward the substrate.

12. The surface mount electrical connector of claim 3, wherein the tine comprises a rectangular aperture.

13. The surface mount electrical connector of claim 3, wherein the tine may be displaced to be substantially coplanar with the substrate.

14. The surface mount electrical connector of claim 3, wherein the tine comprises a soldering portion substantially below and parallel to the retention section and configured for being soldered to the substrate.

15. The surface mount electrical connector of claim 3, wherein the housing is configured to allow a jig to access the tine from above the housing.

16. The surface mount electrical connector of claim 3, wherein the housing is configured to allow a jig to access the tine from above the housing and wherein the jig is configured to bend the tine.

17. The surface mount electrical connector of claim 3, wherein the housing is configured to allow a jig to access the tine from above the housing and wherein the jig is configured to bend the tine toward the substrate.

18. A method of connecting a surface mount electrical connector to a substrate, comprising the steps of:
providing a housing having a contact, the contact having a tine within a projected footprint of the housing on the substrate;
attaching the housing to the substrate;
inserting a jig into an opening of the housing; and
bending the tine toward the substrate.

19. The method according to claim 18, further comprising the steps of:
soldering the tine to the substrate.

20. The method according to claim 18, further comprising the steps of:
after inserting the jig into the opening of the housing and before bending the tine toward the substrate, inserting the jig into a hole of a retention section of the contact.

21. The method according to claim 20, wherein the opening of the housing and the hole of the retention section are substantially vertically aligned.

22. The method according to claim 18, further comprising the steps of:
bending the tine into a position substantially coplanar with the substrate.
